(19) United States
(12) Patent Application Publication
(10) Pub. No.: US 2022/0368740 A1
(43) Pub. Date: Nov. 17, 2022

(54) COORDINATING OUTPUT OF CONTENT DURING A MULTIUSER COMMUNICATION SESSION

(71) Applicant: Apple Inc., Cupertino, CA (US)

(72) Inventors: Jason P. KETTERMAN, San Jose, CA (US); Thomas GOUJON, San Jose, CA (US); Edward T. SCHMIDT, Burlingame, CA (US); Cody D. JORGENSEN, San Jose, CA (US); Arvind S. SHENOY, San Jose, CA (US); Priyo MUSTAFI, Fremont, CA (US); Paul C. IRVINE, Sammamish, WA (US); Won Mo KANG, Cupertino, CA (US)

(21) Appl. No.: 17/744,598

(22) Filed: May 13, 2022

Related U.S. Application Data
(60) Provisional application No. 63/189,150, filed on May 15, 2021.

(51) Int. Cl. H04L 65/403; G06F 3/16

(52) U.S. Cl. CPC H04L 65/403; G06F 3/165

(57) ABSTRACT

The subject technology provides for coordinating output of content during a multiuser communication session by initiating, by a server responsive to a request from a first participant device of a plurality of participant devices that are connected to a multiuser communication session, a media playback session for the multiuser communication session. A network identifier corresponding to the media playback session is generated at the server. The network identifier is transmitted by the server to remainder of participant devices connected to the multiuser communication session. Upon receiving an indication of a selection of the network identifier from at least a second participant device of the plurality of the participant devices at the server, the server causes media for the media playback session to be transmitted to the first participant device and the second participant device.

### CROSS REFERENCE TO RELATED APPLICATIONS

This application claims the benefit of priority to U.S. Provisional Patent Application No. 63/189,150, entitled “Coordinating Output of Content During a Multiuser Communication Session,” and filed on May 15, 2021, the disclosure of which is hereby incorporated herein in its entirety.

### TECHNICAL FIELD

The present description relates generally to controlling output of content, including coordinating output of content during a multiuser communication session.

### BACKGROUND

A user of an electronic device may participate in audio and/or video conferencing with other participants using their respective devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for coordinating output of content during a multiuser communication session in accordance with one or more implementations.

FIG. 2 illustrates an example device that may participate in a multiuser communication session in accordance with one or more implementations.

FIG. 3 illustrates an example electronic device that may participate in a multiuser content access session in accordance with one or more implementations.

FIG. 4 illustrates a flow diagram of an example process for coordinating output of content during a multiuser communication session in accordance with one or more implementations.

FIG. 5 illustrates a flow diagram of an example process for resolving conflicting commands for modifying a list of media items in accordance with one or more implementations.

FIG. 6 illustrates a flow diagram of an example process for selecting a replacement media item for a participant device that is ineligible to receive a designated media item in accordance with one or more implementations.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Audio-video conferencing provides for the reception and transmission of audio and/or video signals by user devices (e.g., at different locations), for communication between users in real-time. In some cases, two users may utilize audio-video conferencing to communicate with each other in one-to-one communication at their respective devices. In other cases, multiway audio-video conferencing may be utilized by more than two users to participate in a real-time, group conversation.

Depending on the purpose of a multiuser communication session, participants of the session may choose to concurrently access content such as, e.g., audio and/or video content such that multiple participants can listen to and/or view the content during the session. For example, one or more users in a multiuser communication session may want to concurrently access audio and/or video media with other participants in the session to create a co-listening and/or co-viewing session such that multiple (e.g., all) of the participants are accessing the same media at substantially the same time.

The subject system allows a user in a multiuser communication session (e.g., on a multiuser audio-video conference call) to concurrently access content with other users in the communication session. For example, during a multiuser communication session, any user can initiate a multiuser content access session (e.g., a multiuser media playback session) for co-listening to songs, and/or for creating and/or sharing a playlist of songs. The multiuser content access session may be coordinated through the server such that each of the participants in the session is accessing the same content queue (e.g., playlist), and such that the playback of content from the content queue occurs substantially simultaneously across the participants in the session.

The subject system provides for a multiuser content access session to be synchronized such that multiple participants can output the same content at the substantially the same time point (e.g., listen to the same song at the same playback position). Additionally, in certain scenarios multiple (e.g., all) participants may be enabled to have access to, and/or control of, the content and the content queue, such that one or more participants can add or remove content in the content queue, or rearrange the content queue.

The subject system further provides for a device (e.g., a server and/or one of the participant devices) hosting the multiuser content access session to resolve conflicts in the content queue when different participants modify the content queue in a conflicting manner. In instances where a given content item is a media item (e.g., a song) which cannot be accessed by an individual participant device because of restrictions (e.g., the participant does not have access to the media item), the server may select a replacement media item for playback at the individual participant device, such as a different version of the media item that the participant device has access to and/or a different media item entirely. In such instances, the playback position for the replacement media item may be synchronized to allow a smooth transition through the content queue to the next media item.

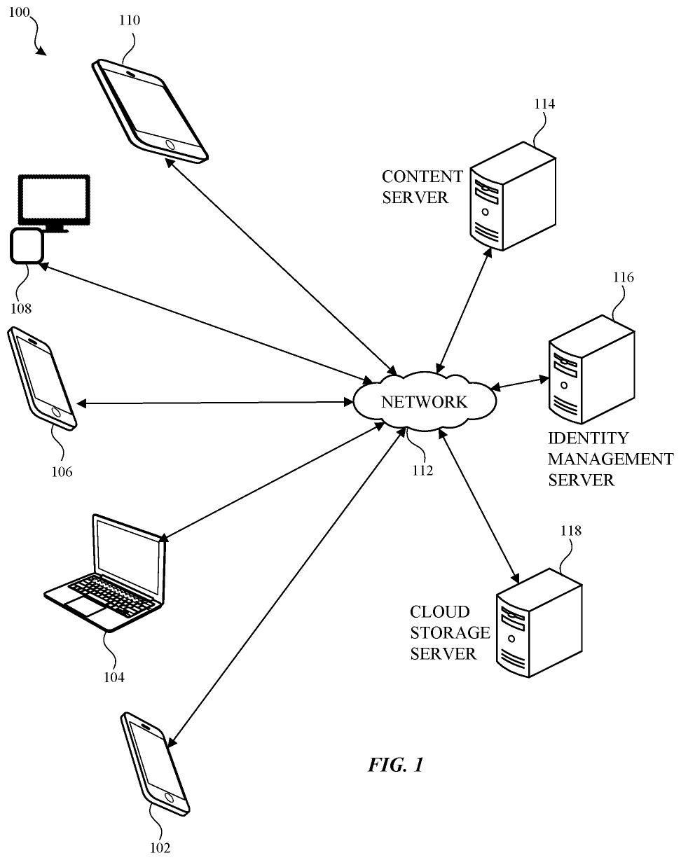

FIG. 1 illustrates an example network environment 100 for coordinating output of content during a multiuser communication session in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes electronic devices 102, 104, 106, 108 and 110 (hereinafter “the electronic devices 102-110”), a media content server 114, an identity management server 116 and a cloud storage server 118 (hereinafter “the servers 114-118”), and a network 112. The network 112 may communicatively (directly or indirectly) couple, for example, any two or more of the electronic devices 102-110 and/or the servers 114-118. In one or more implementations, the network 112 may be an interconnected network of devices that may include, and/or may be communicatively coupled to, the Internet. In one or more implementations, the network 112 may correspond to a local area network (e.g., a WiFi network) connecting one or more of the electronic devices 102-110. For explanatory purposes, the network environment 100 is illustrated in FIG. 1 as including electronic devices 102-110 and servers 114-118; however, the network environment 100 may include any number of electronic devices and any number of servers.

One or more of the electronic devices 102-110 may be, for example, a portable computing device such as a laptop computer, a smartphone, a smart speaker, a digital media player, a peripheral device (e.g., a digital camera, headphones), a tablet device, a wearable device such as a smartwatch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone, the electronic device 104 is depicted as a laptop computer, the electronic device 106 is depicted as a smartphone (“smartphone 2”), and the electronic device 110 is depicted as a tablet. By way of example, the electronic device 108 is depicted as a desktop computer. In one or more implementations, one or more of the electronic devices 102-110 may be referred to as a content output device.

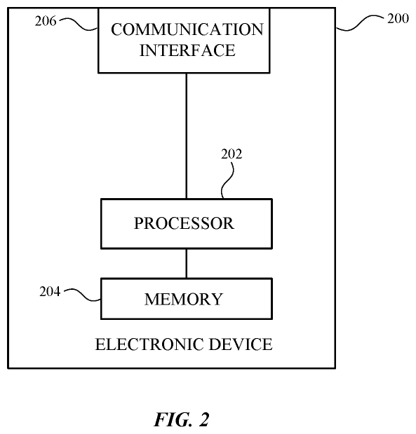

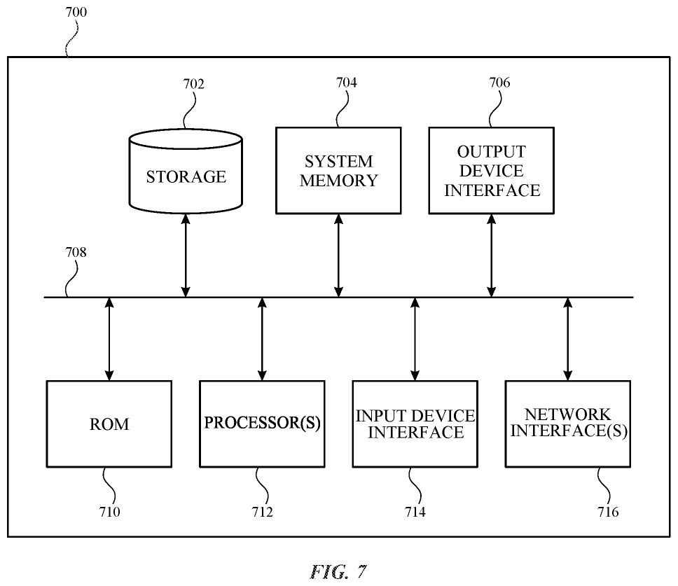

One or more of the electronic devices 102-110 may be configured to communicate or otherwise interact with one or more of the servers 114-118. One or more of the electronic devices 102-110 may be, and/or may include all or part of, the device discussed below with respect to FIG. 2, and/or the electronic system discussed below with respect to FIG. 7.

In one or more implementations, the content server 114 may be configured to provide content (e.g., via streaming and/or download) for output on a device (e.g., one or more of the electronic devices 102-110). In one or more implementations, the content server 114 may be configured to cause a separate server such as, for example, the cloud storage server 118, to provide (e.g., via streaming and/or download) content for output on a device. In one or more implementations, the content server 114 may be configured to host a multiuser content access session such as, for example, a media playback session, in which the content selected by users of one or more electronic devices participating in a multiuser communication session is output to participating electronic devices 102-110.

A user of any of the electronic devices 102-110 participating in the multiuser communication session (also referred to herein as “participant devices”) may choose to initiate a multiuser content access session within the multiuser communication session by transmitting a request to the content server 114 from the corresponding participant device. The content server 114, upon receiving a request from the corresponding participant device connected to the multiuser communication session, initiates the multiuser content access session for the multiuser communication session and hosts the multiuser content access session.

Once a multiuser content access session is initiated, the content server 114 may generate a network identifier such as, for example, a unique resource link (URL), corresponding to the multiuser content access session. The content server 114 then transmits the network identifier to each of the participant devices connected to the multiuser communication session.

A user of any of the participant devices may choose to participate in the multiuser content access session within the multiuser communication session on the corresponding participant device by accessing the multiuser content access session hosted on the content server 114 by selecting the network identifier received on the corresponding participant device. Upon receiving an indication of the user selection, the content server 114 transmits the content being requested to the participant devices that have selected to participate in the multiuser content access session within the multiuser communication session. In one or more implementations, the content server 114 may cause the content to be transmitted from the cloud storage server 118 which may serve as cloud-based storage for the content being accessed via the multiuser content access session.

In one or more implementations, the content server 114, upon initiating the multiuser content access session, may transmit information relating to the multiuser content access session to one or more of the participant devices connected to the multiuser content access session. For example, if the multiuser content access session is a co-listening session for listening to a list of songs, the content server 114 may transmit the list of songs to multiple (e.g., all) of the participant devices connected to the co-listening session. The application enabling the co-listening session may then display the list of songs on the corresponding participant device. In addition, in one or more implementations, the application enabling the co-listening session may also enable the user of the corresponding participant device to modify the list and/or control the transmission of the songs from the content server 114. In such implementations, the content server 114 may relay the commands received from a particular participant device to multiple (e.g., all) of the participant devices connected to the co-listening session.

In one or more implementations, the content server 114 may enable each of the participants to modify a content library, a list of the content to be output and/or a temporal position for the content being output to the participant devices. For example, the content server 114 may enable each of the electronic devices 102-110 to add or remove content from a list of content to be output through the server, change the position of content within the list, and/or control the temporal position of the content being output currently regardless of which electronic device has initiated the multiuser content access session and/or the multiuser communication session.

In some scenarios, users of two of the participant devices may initiate commands to modify the list of the content to be accessed that conflict with each other. For example, a first user may transmit a command to the content server 114, through a first electronic device, to move a content item from the list down to be accessed at a later time while a second user may transmit a command to the content server 114, through a second electronic device, to move the same content item up the list to be accessed immediately after the currently accessed content item. The content server 114 may be configured, in such scenarios, to transform the conflicting commands to form a transformed command. The list of the content is then reorganized in accordance with the transformed command. The content is output to the participant devices according to the reorganized list.

In one or more implementations, the content server 114 deconflicts the list using an operational transform. Alternatively, in one or more implementations, the content server 114 deconflicts the list by capturing each user's intent and then transforming the intent to reorganize the list.

In one or more implementations, the content server 114 may synchronize the content being accessed such that each participating device outputs the same content item from the content queue at substantially the same time. In one or more implementations, the content server 114 may synchronize the content such that each participating device outputs the content item at a same temporal position within the content item being accessed.

For example, if the requested content includes a list of songs to be output to the participating devices, the content server 114 may synchronize the content such that multiple (e.g., all) of the participant devices output the same song at a given time. In one or more implementations, the playback position within the song being played is synchronized such that multiple (e.g., all) of the participant devices output the song being played at the same playback position within the song.

Thus, in one or more implementations depending on the latency of communication between the content server 114 and the different participant devices, the content server 114 may transmit the content item to different participant devices at different time points such that the content item is received at, and output by, each participant device at the same time and at the same temporal position within the content item.

In some scenarios, where the content server 114 causes a cloud storage server 118 to transmit the content, the content server 114 may cause transmission of the content from multiple cloud storage servers 118 selected such that the latency between the transmitting server and the participant devices is minimized. Thus, for example, if a first participant device is at a location in Japan and other participant devices are at locations in the United States, a cloud storage server 118 located in Japan (or the next closest location to Japan) may be selected for transmitting the content to the first participant device and a cloud storage server 118 located in the United States is selected for transmitting the content to the other participant devices. Further even among the participant devices in the United States, cloud storage servers at locations relatively closer individual participant devices may be selected for transmitting the content to those individual participant devices.

In one or more implementations, the content server 114 may also be configured to determine restrictions on the content such as, for example, those relating to copyright, subscription or purchase rights, and/or geographical or jurisdictional constraints which may prevent certain media from be accessed in certain jurisdictions or geographical areas. Thus, in some scenarios, a particular participant device may be ineligible to receive a particular content item from the content queue. In such scenarios, the content server 114 may determine whether a particular participant device is ineligible (because of any of the various restrictions) to receive a particular content item from the content queue. Upon a determination that a given participant device is ineligible to receive a designated content item, the content server 114 may select a replacement content item that the given participant device is eligible to receive, and transmit (or cause to transmit) the replacement content item instead of the designated content item to the given participant device.

The replacement content item may be selected based on one or more matching criteria such as, for example, similarity with the designated content item or a temporal length of the designated content item in one or more implementations. For example, in scenarios where content items are songs, the replacement content item may be selected to have a same or similar duration, a same or similar genre, same or similar artist(s), same or similar language and the like as that of the designated content item, and/or may be a different version of the same song that the user has access to.

The identity management server 116 may be configured to verify and/or manage user account identifiers (IDs) associated with user accounts and/or devices. For example, in one or more implementations, the identity management server 116 may provide the geographical location where a particular electronic device is located based on the account identifiers and/or metadata relating to the user's access to the network.

The cloud storage server 118 may be configured to store data (e.g., files such as documents and/or photos) associated with user accounts for download on user devices, to share and/or send data to other users, and/or to back-up (e.g., wirelessly) device data.

Moreover, in one or more implementations, users may have user accounts that are managed by the identity management server 116, and the user accounts may be associated with content libraries (e.g., music and/or video content) provided by the content server 114. The content libraries may include, for example, subscription based content, purchased content (e.g., that is not available through a subscription), user-uploaded and/or generated content (such as user-created music or music transferred by a user from a compact disc), and/or user-generated playlists.

For example, the cloud storage server 118 may include custom user playlists and user provided and/or generated content that is separate from the content stored in the content server 114. The user provided and/or generated content may include music extracted from physical media that is stored in cloud storage, and/or content that is no longer available from the content server 114.

One or more of the servers 114-118 may be, and/or may include all or part of the electronic system discussed below with respect to FIG. 7. One or more of the servers 114-118 may include one or more servers, such as a cloud of servers. For explanatory purposes, a single server is shown and discussed with respect to various operations for each of the servers 114-118. However, these and other operations discussed herein may be performed by one or more servers, and each different operation may be performed by the same or different servers. For example, the content server 114 may represent one or more voice assistant server(s) that are in communication with one or more separate content server(s). In one or more implementations, communications between the one or more voice assistant server(s) and one or more of the electronic devices 102-110 may be anonymous.

In one or more implementations, one or more of the electronic devices 102-110 may be configured to be associated with and/or registered with, multiple user accounts, such as with the identity management server 116. One or more of the electronic devices 102-110, such as the electronic devices 104, 108, 110, configured to be associated with and/or registered with multiple user accounts may be referred to as multiuser devices, while one or more of the electronic devices 102-110, such as the electronic devices 102, 104, 106, configured to be associated with and/or registered with one user account may be referred to as a single user device. In one or more implementations, each of the electronic devices 102-110 may be configured to access the content libraries of the one or more users accounts that are registered with and/or associated with each of the electronic devices 102-110.

FIG. 2 illustrates an example device that may participate in a multiuser communication session in accordance with one or more implementations. For example, the device 200 of FIG. 2 can correspond to any of the electronic devices 102-110 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The device 200 may include a processor 202, a memory 204, and a communication interface 206. The processor 202 may include suitable logic, circuitry, and/or code that enable processing data and/or controlling operations of the device 200. In this regard, the processor 202 may be enabled to provide control signals to various other components of the device 200. The processor 202 may also control transfers of data between various portions of the device 200. Additionally, the processor 202 may enable implementation of an operating system or otherwise execute code to manage operations of the device 200.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, in a case where the device 200 corresponds to one of the electronic devices 102-110, the memory 204 may store an application (e.g., an audio-video conferencing application) which is configured to facilitate in providing and receiving multiple content streams and/or parity streams as part of an audio-video conference. In one or more implementations, the audio-video conferencing application may be part of or otherwise incorporated within the operating system of the electronic devices 102-110. In one or more implementations, the memory 204 may store one or more content output applications for outputting content via the device 200. Examples of such applications, include but not are limited to, a music playback application.

The communication interface 206 may include suitable logic, circuitry, and/or code that enables wired or wireless communication, such as between any of the electronic devices 102-110 and one or more of the servers 114-118 over the network 112. The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

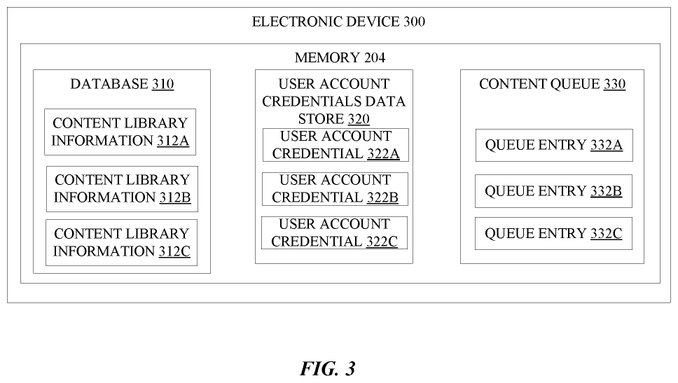

FIG. 3 illustrates an example electronic device that may participate in a multiuser content access session in accordance with one or more implementations. The electronic device 300 may be any of the electronic devices 102-110, or any other compatible electronic device. As shown in FIG. 3, the electronic device 300 may include a database 310, user account credentials data store 320, and a content queue 330, which may be stored in, for example memory 204 as shown in FIG. 2. The database 310 may store content library information 312A-C, the user account credentials data store 320 may store user account credentials 322A-C. The content queue 330 may include queue entries 332A-C.

In one or more implementations, the electronic device 300 may be used in a multiuser home environment that includes, for example, two or more (e.g., three) users. By proceeding through a user onboarding process that may be guided by interfaces provided on e.g. any of the electronic devices 102-110, the three users may respectively authorize user account credentials 322A, 322B, and 322C to be stored within the user account credentials data store 320 of the electronic device 300. The user account credentials 322A-C may, for example, be received from the identity management server 116 to access content stored on the content server 114 and/or the cloud storage server 118.

In one or more implementations, one or more of the user account credentials 322A-C may include one or more of a user account identifier, a user account password, a cryptographic token (such as an access token), or generally any information that may be used to authenticate the user accounts of the users with, e.g., the content server 114. For example, an access token may include information that identifies a user account, such as at least a portion of a user account identifier, and the access token may be signed by a private key of the content server 114. In one or more implementations, the user account credentials 322A-C may be used to retrieve access credentials, such as from the cloud storage server 118, and the access credentials may be used to access the corresponding content libraries via the content server 114.

The database 310 may store content library information 312A-C corresponding to the content libraries of the user accounts registered with the electronic device 300. For example, each of the content library information 312A-C may include metadata, including network identifiers that provide a reference, or link, to each content item in the corresponding content library. The network identifiers may refer to content provided by the content server 114, and/or user provided and/or generated content that may be stored on the cloud storage server 118. The metadata may further include a content identifier corresponding to each content item as well as descriptive information corresponding to each content item, such as a track name, an artist name, an album name, and the like. In one or more implementations, the metadata may further include information relating to copyright, purchase or subscription rights, and/or geographical or jurisdictional restrictions. In one or more implementations, the content library information 312A-C may be downloaded to the electronic device 300 at the time that the user accounts are registered with the electronic device 300.

In one or more implementations, the content identifier corresponding to a given content item in the content library information 312A may differ from the content identifier corresponding to the same given content information in the content library information 312B. Thus, the content identifiers may be specific to each of the individual content library information 312A-C.

Once a user account is registered with the electronic device 300, and the corresponding content library information is downloaded to the electronic device 300, the electronic device 300 may receive a notification when the content library associated with the user account changes and/or is updated. The electronic device 300 may responsively retrieve updated content library information corresponding to the updated content library and may store the updated content library information in the database 310. In this manner, the electronic device 300 may continuously maintain/update the content library information 312A-C. In one or more implementations, the electronic device 300 may request (e.g., pull) any updates to a particular content library information, such as the content library information 312A, when switching to the content library information 312A from another of the content library information 312B-C.

The content queue 330 may comprise a list of queue entries 332A-C, where each queue entry may include a user account identifier identifying a user account registered with the electronic device 300 (and/or an identifier of/link to the corresponding user account credential), and a content identifier corresponding to a particular content item in the content library corresponding to the user account. In one or more implementations, one or more of the queue entries 332A-C, such as the queue entry 332A, may further include a requesting user account identifier corresponding to the user account of the user who requested to have the queue entry 332A added to the content queue 330.

In one or more implementations, a user account may be delegated to the electronic device 300 where the content library information corresponding to the user account is not stored on the electronic device 300, but a user account credential for accessing, or temporarily accessing, at least a portion of the content library of the user account is stored on the electronic device 300. For example, an electronic device 102 of a new participant in the multiuser communication session may temporarily (e.g., for the duration of the communication session) grant access to the content library of the electronic device 102 to the electronic device 300, either directly or via the server 114. In this example, the queue entry for content added from the content library of the electronic device 102 may include a network identifier for accessing the content, such as from the content server 114, as well as an account identifier of the user account of the new participant (and/or other information for accessing the user account credential for accessing the content library of electronic device 102).

The electronic device 300 may playback the content in the content queue 330 in a sequential and/or shuffled order. In comparison to a playlist that is limited to content of the content library of a single user account, the content queue 330 may include queue entries 332A-C that reference content from the library of any user account registered with the electronic device 300. In this manner, users in a household with user accounts registered with the electronic device 300 can readily add content from their content libraries to the same content queue 330, providing facilitated access to multiple (e.g., all) content libraries of users registered with the electronic device 300, such as multiple (e.g., all) users in the same home.

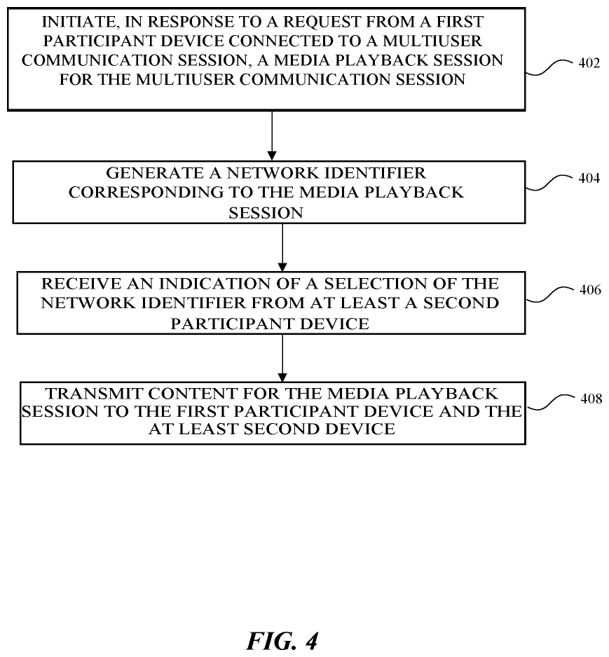

FIG. 4 illustrates a flow diagram of an example process 400 for coordinating output of content during a multiuser communication session in accordance with one or more implementations. For explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations. Furthermore, while the process illustrated in FIG. 4 uses a media (e.g., songs) playback session within a multiuser communication session as an example, the method is also applicable to access of other content within a multiuser communications session.

In one or more implementations, a process 400 for coordinating output of content during a multiuser communication session may include initiating (402), by a server, responsive to a request from a first participant device of a plurality of participant devices that are connected to a multiuser communication session, a media playback session for the multiuser communication session. A user of the first participant device may desire to initiate a media playback session while in the multiuser communication session. Accordingly, the user may issue a command through the first participant device from within the multiuser communication session to initiate the media playback session. Upon receiving the command from the first participant device, the server hosting the multiuser communication session may initiate the media playback session.

The server may then generate (404) a network identifier corresponding to the media playback session. The network identifier may be, for example, a unique resource link (URL) that provides a navigation address for a user to access media playback session on the server through the network (e.g., the Internet) using which the plurality of participant devices are connected to the multiuser communication session.

The server may then transmit the generated network identifier to the remainder of the plurality of participant devices connected to the multiuser communication session. The network identifier may be presented on the respective participant devices as a notification within the multiuser communication session In one or more implementations. Depending on the settings of the individual devices and/or the settings of the application being used for the multiuser communication session, the participant devices may receive the network identifier by various means such as, for example, a pop-up screen in the application, a pop-up notification on the corresponding participant device, a text message via the cellular network, and the like. A user of the participant device receiving the network identifier choosing to participate in the media playback session may access the media playback session via the network identifier. In contrast, the a user choosing not to participate in the media playback session may ignore the network identifier and may continue to stay connected to the multiuser communication session or may choose to exit the multiuser communication session.

Upon receiving (406) an indication that a user of at least a second participant device has selected to access the media playback session via the network identifier, the server transmits (408) the media content (or causes the media content to be transmitted) for the media playback session to the first participant device and at least the second device. The media content may be transmitted to the corresponding participant devices via streaming and/or download.

In one or more implementations, the media content is stored on the server as a list of media items (e.g., a playlist for songs) to be transmitted to the corresponding participant devices in a sequential order. In one or more implementations, only the list of media items is stored on the server while the media items are stored on a separate server such as, for example, a cloud storage server. In such implementations, the server hosting the multiuser communication session and the media playback session may cause the cloud storage server to transmit the media items to the corresponding participant devices in accordance with the list of media items.

In one or more implementations, the transmission of media items is synchronized such that each of the participant devices connected to the media playback session receives the same media item and outputs the media item at substantially the same time. Moreover, in one or more implementations, the transmission of media items is synchronized such that each of the participant devices connected to the media playback session can output the media item at the same playback position within the media item. Thus, for example, in some scenarios, the transmission of the media items to different participant devices may be temporally spaced apart. In one or more implementations, the synchronization of playback positions across different participant devices may be achieved by affecting transmission of media items from different cloud storage servers based on latency of communication between individual participant devices and various cloud storage servers that are capable of transmitting the particular media item. In one or more implementations, the information relating to the latency of communication between individual participant devices and various cloud storage servers capable of transmitting different media items is determined and analyzed by the server hosting the media playback session.

In one or more implementations, each user participating in the media playback session is enabled to control the media item being currently transmitted to the participant devices. For example, any user participating in the media playback session may take actions such as pause, play, skip forward within the currently transmitted item, skip backward within the currently transmitting item, skip forward within the playlist, skip backward within the playlist, and the like. In such implementations, the control commands provided by any of the users participating in the media playback session are relayed to each of the participant devices outputting the media item via the server hosting the media playback session such that the output of the media item on each of the participant devices is controlled in accordance with the control commands. Thus, any user participating in the media playback session can control the output of the media item for multiple (e.g., all) of the participant devices connected to the multiuser communication session.

In one or more implementations, each user participating in the media playback session is enabled to modify the list of media items to be transmitted during the media playback session. For example, any user participating in the media playback session, through the respective participant device, may add or remove media items to the list of media items, or rearrange the list of media items to change the order in which the media items are transmitted during the media playback session. It will be appreciated that enabling multiple (e.g., all) of the users participating in the media playback session to modify the list of media items may lead to conflicting commands in some scenarios.

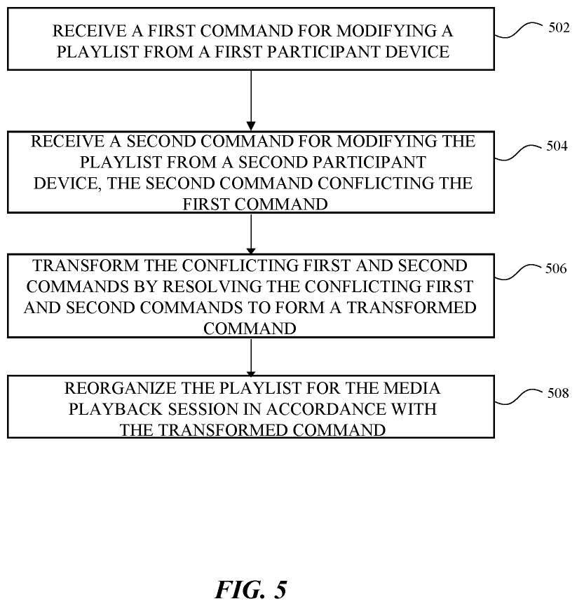

FIG. 5 illustrates a flow diagram of an example process 500 for resolving conflicting commands for modifying a list of media items in accordance with one or more implementations. For explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In one or more implementations, a process 500 for resolving conflicting commands for modifying a list of media items to be transmitted during a media playback session may include receiving (502), at the server hosting the media playback session, a first command for modifying a playlist from a first participant device. The first command may include, but is not limited to, adding a media item to the list, removing a media item from the list, moving a media item already on the list up or down so as to change the order of media items being played, and the like.

At the same time as or subsequent to a first user issuing the first command via the first participant device, a second user may issue a second command via a second participant device to modify the list of media items. In some scenarios, the second command may conflict the first command. For example, while the first command may correspond to moving a particular media item ahead within the order of play, the second command may correspond to moving the same media idea further back within the order of play. The server hosting the media playback session receives (504) the second command and determines the conflict.

Upon determining that the second command conflicts the first command, the conflicting first and second commands are resolved and transformed (506) to form a transformed command so as to resolve the conflicting commands. In one or more implementations, the resolving of the conflicting commands is achieved using operational transformation algorithms. The operational transformation algorithms may be designed to maintain consistency of one or more of causality preservation, convergence, intention preservation, admissibility, and the like. Alternatively, in one or more implementations, the resolving is achieved by capturing each user's intent and then transforming the intent to reorganize the list.

In one or more implementations, upon receipt of the first command, the server may delay operating on that command for a certain amount of time to allow other users to issue their commands, and if no command is received within a predetermined amount of time after the first command, the server may then operate on that command. If, on the other hand, one or more conflicting second commands are received within the predetermined amount of time, the server may resolve the conflicting commands using a suitable transformation algorithm.

The list is then reorganized (508) based on the transformed command, and the media playback session is continued based on the reorganized list.

In some scenarios, the content items included in the list of items to be transmitted during a multiuser content access session may have restrictions associated therewith. For example, in a scenario where the content item is a song or a video, the song or the video may be restricted from access from particular geographical areas or jurisdictions. In such scenarios, a participant device located in that particular geographical area or jurisdiction may be ineligible to receive one or more content items from the list of items to be transmitted during the multiuser content access session.

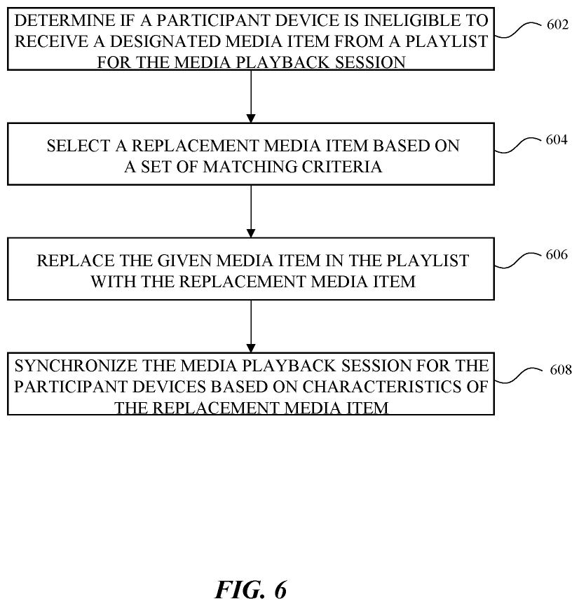

FIG. 6 illustrates a flow diagram of an example process 600 for selecting a replacement media item for a participant device that is ineligible to receive a designated media item. For explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

In one or more implementations, the process 600 for selecting a replacement media item for a participant device that is ineligible to receive a designated media item may include determining (602) if a participant device is ineligible to receive a designated media item from a playlist for a media playback session. The participant device may be ineligible to receive the designated media item for various reasons including, for example, geographical or jurisdictional restrictions, copyright restrictions, device capability restrictions, subscription and/or purchase rights related restrictions, and the like.

Upon determination that a participant device is ineligible to receive a designated media item, a replacement media item is selected (604) based on a set of matching criteria. The matching criteria may include, but are not limited to, the temporal length, language, genre, artist, and the like.

Upon selecting a suitable replacement media item, the designated media item is replaced (606) with the replacement media item within the playlist to be transmitted to the particular participant device that is ineligible to receive the designated media item. In one or more implementations, a notification may be transmitted to the particular participant device to notifying the user of the participant device that the designated media item is replaced with the replacement media item.

The media playback session is then synchronized (608) for multiple (e.g., all) of the participant devices participating in the media playback session based on the characteristics of the replacement media item. For example, if the replacement media item has a temporal length that is the same as the designated media item, the playlist is transmitted without any substantial changes.

On the other hand, if the replacement media item has a temporal length different from that of the designated media item, the transmission of the media items may be suitably modified. For instance, in some scenarios, the replacement media item may be lengthened or shortened to match the temporal length of the designated media item. Alternatively, the designated media item may be lengthened or shortened to match the temporal length of the replacement media item. In one or more implementations, the temporal length of the media items prior to and/or subsequent to the designated media item in the playlist may be suitably changed for the particular participant device and/or the remainder of the participant devices to provide a smoother transition between media items. The temporal length may be modified by, for example, providing a suitable pause between media items, providing a fade in or a fade out at a transition between media items, and the like.

As described above, one aspect of the present technology is to provide a method to enable users in a multiuser communication session (e.g., on a multiuser audio-video conference call) to concurrently access content during the multiuser communication session. The method allows any user connected to a multiuser communication session to initiate a multiuser content access session for co-experiencing the content. For example, any user connected to a multiuser communication session may initiate a session for co-listening (and/or watching) songs, and create and share a playlist of songs. The multiuser content access session may be run through a server, and thus, multiple (e.g., all) of the participants on the group call can have access to the same content queue and can also control the playback of the content across multiple (e.g., all) of the participant devices.

Another aspect of the present technology enables resolving conflicts in content queue in the instances where different participants modify the content queue in different ways. Moreover, in instances where a given content item is a media item (e.g., a song) which cannot be accessed by an individual participant because of restrictions, an aspect of the present technology allows for selection of a suitable replacement media item in lieu of the given media item.

Another aspect of the present technology enables synchronization of content being transmitted to participant devices and output by the participant devices such that multiple (e.g., all) of the participant devices output the same content at substantially the same time and at substantially the same temporal position within the content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of accessing content or other data from a remote device, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use and/or access of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, insertion of content or other data from a remote device can be performed based on non-personal information data or a bare minimum amount of personal information, such as the content being requested by the device associated with a user, other non-personal information available to the application obtaining the content or other data, or publicly available information.

FIG. 7 illustrates an electronic system 700 with which one or more implementations of the subject technology may be implemented. The electronic system 700 can be, and/or can be a part of, the electronic device 110, the electronic device 130, and/or the server 120 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

In accordance with various aspects of the subject disclosure, a method may include initiating, by a server responsive to a request from a first participant device of a plurality of participant devices that are connected to a multiuser communication session, a media playback session for the multiuser communication session. A network identifier corresponding to the media playback session is generated at the server. The network identifier is transmitted by the server to remainder of participant devices connected to the multiuser communication session. Upon receiving an indication of a selection of the network identifier from at least a second participant device of the plurality of the participant devices at the server, the server causes media for the media playback session to be transmitted to the first participant device and the second participant device.

In accordance with various aspects of the subject disclosure, a system may include a plurality of participant devices connected to the multiuser communication session via a network, and a server connected to the plurality of participant devices via the network. The server is configured to initiate, responsive to a request from a first participant device of the plurality of participant devices, a media playback session for the multiuser communication session. A network identifier corresponding to the media playback session is generated. The network identifier is transmitted to remainder of participant devices connected to the multiuser communication session. Upon receipt of an indication of a selection of the network identifier from at least a second participant device of the plurality of the participant devices, the server causes media for the media playback session to be transmitted to the first participant device and the second participant device.

In accordance with various aspects of the subject disclosure, a non-transitory computer-readable medium is provided that includes instructions, which when executed by at least one computing device, cause the at least one computing device to initiate, responsive to a request from a first participant device of the plurality of participant devices, a media playback session for the multiuser communication session. A network identifier corresponding to the media playback session is generated. The network identifier is transmitted to remainder of participant devices connected to the multiuser communication session. Upon receipt of an indication of a selection of the network identifier from at least a second participant device of the plurality of the participant devices, the computing device causes media for the media playback session to be transmitted to the first participant device and the second participant device.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
initiating, by a server responsive to a request from a first participant device of a plurality of participant devices that are connected to a multiuser communication session, a media playback session for the multiuser communication session;
generating, at the server, a network identifier corresponding to the media playback session;
transmitting, by the server, the network identifier to remainder of participant devices connected to the multiuser communication session;
receiving, at the server, an indication of a selection of the network identifier from at least a second participant device of the plurality of the participant devices; and
causing, by the server, media for the media playback session to be transmitted to the first participant device and the second participant device.

2. The method of claim 1, wherein the server stores a list of media items for the media playback session, the method further comprising controlling, by the server, the media playback session according to the list on the first and second participant devices.

3. The method of claim 2, wherein controlling the media playback session further comprises one or more of: adding a media item to the list, removing a media item from the list, rearranging a playback order of media items in the list, and controlling a media item being currently transmitted.

4. The method of claim 2, further comprising:
receiving, at the server, a first command for controlling the list from the first participant device;
receiving, at the server, a second command for controlling the list from the second participant device, the second command conflicting with the first command;
transforming, at the server, the conflicting first and second commands to resolve the first and second commands to form a transformed command; and
reorganizing, at the server, the list for the media playback session in accordance with the transformed command to obtain a reorganized list and transmitting media items to the plurality of participant devices in accordance with the reorganized list.

5. The method of claim 2, further comprising synchronizing, by the server, the list of media items to be transmitted to the first participant device and the second participant device for the media playback session.

6. The method of claim 2, further comprising synchronizing a playback position of the media items being currently transmitted to the first participant device and the second participant device for the media playback session.

7. The method of claim 1, wherein the server causes a cloud-based database to transmit content to the first participant device and the second participant device for the media playback session.

8. The method of claim 1, wherein the plurality of participant devices are located in a plurality of respective geographical locations, and
wherein the method further comprises selecting, by the server, media items for inclusion in the media playback session for at least one of the plurality of participant devices based on the respective geographical location of the at least one of the plurality of participant devices.

9. The method of claim 1, further comprising:
determining, by the server, that one of the plurality of participant devices is ineligible to receive a given media item from a list for the media playback session; and
replacing, by the server, the given media item in the list with a replacement media item.

10. The method of claim 9, wherein the replacement media item is selected based on a set of matching criteria including a temporal length of the given media item.

11. The method of claim 9, further comprising synchronizing the media playback session for the first and second participant devices based on characteristics of the replacement media item.

12. A non-transitory computer-readable medium is provided that includes instructions, which when executed by at least one computing device, cause the at least one computing device to:
initiate, responsive to a request from a first participant device of a plurality of participant devices that are connected to a multiuser communication session, a media playback session for the multiuser communication session;
generate a network identifier corresponding to the media playback session;
transmit the network identifier to remainder of participant devices connected to the multiuser communication session;
receive an indication of a selection of the network identifier from at least a second participant device of the plurality of the participant devices; and
cause media for the media playback session to be transmitted to the first participant device and the second participant device.

13. The non-transitory computer-readable medium of claim 12, wherein the instructions further cause the at least one computing device to:
receive a first command for controlling a list of media items for the media playback session from the first participant device;
receive a second command for controlling the list from the second participant device, the second command conflicting with the first command;
transform the conflicting first and second commands to resolve the conflicting first and second commands to form a transformed command; and
reorganize the list for the media playback session in accordance with the transformed command to obtain a reorganized list and transmitting media items to the plurality of participant devices in accordance with the reorganized list.

14. The non-transitory computer-readable medium of claim 12, wherein the instructions further cause the at least one computing device to:
determine that one of the plurality of participant devices is ineligible to receive a given media item from a list for the media playback session; and
replace the given media item in the list with a replacement media item, the replacement media item being selected based on a set of matching criteria including a temporal length of the given media item.

15. A system comprising:
a plurality of participant devices connected to a multiuser communication session via a network; and
a server connected to the plurality of participant devices via the network, and comprising a processor configured to:
initiate, responsive to a request from a first participant device of the plurality of participant devices, a media playback session for the multiuser communication session;
generate a network identifier corresponding to the media playback session;
transmit the network identifier to remainder of participant devices connected to the multiuser communication session;
receive an indication of a selection of the network identifier from at least a second participant device of the plurality of the participant devices; and
cause media for the media playback session to be transmitted to the first participant device and the second participant device.

16. The system of claim 15, further comprising a cloud storage server storing media to be transmitted during the media playback session, wherein the server causes the cloud storage server to transmit the media to the first and second participant devices.

17. The system of claim 15, wherein the server is further configured to: control, upon receiving a control command from any of the first and second participant devices, the media playback session, wherein controlling the media playback session comprises one or more of: adding a media item to a list of media items for the media playback session, removing a media item from the list, rearranging a playback order of media items in the list, and controlling a media item being currently transmitted.

18. The system of claim 15, wherein the server is further configured to:
receive a first command for controlling a list of media items for the media playback session from the first participant device;
receive a second command for controlling the list from the second participant device, the second command conflicting with the first command;
transform the conflicting first and second commands to resolve the conflicting first and second commands to form a transformed command; and
reorganize the list for the media playback session in accordance with the transformed command to obtain a reorganized list and transmitting media items to the plurality of participant devices in accordance with the reorganized list.

19. The system of claim 15, wherein the server is further configured to:
determine that one of the plurality of participant devices is ineligible to receive a given media item from a list for the media playback session; and
replace the given media item in the list with a replacement media item, the replacement media item being selected based on a set of matching criteria including a temporal length of the given media item.

20. The system of claim 19, wherein the server is further configured to synchronize the media playback session for the first and second participant devices based on characteristics of the replacement media item.
